(19) United States
(12) Patent Application Publication
(10) Pub. No.: US 2015/0262442 A1
(43) Pub. Date: Sep. 17, 2015

(54) APPARATUS AND METHOD FOR VEHICLE MANAGEMENT AND CONTROL

(71) Applicant: Wistron Corporation, New Taipei City (TW)

(72) Inventors: Hong-Chi Chen, New Taipei City (TW); Yao-Tsung Chang, New Taipei City (TW); Tai-Chuan Chen, New Taipei City (TW); Chien-Hsin Liu, New Taipei City (TW); Shao-Lun Chao, New Taipei City (TW)

(21) Appl. No.: 14/307,511

(22) Filed: Jun. 18, 2014

(30) Foreign Application Priority Data
Mar. 13, 2014 (TW) 103109033

(51) Int. Cl. G07C 9/00

(52) U.S. Cl. CPC G07C 9/00309; G07C 9/00007; G07C 2009/00769

(57) ABSTRACT

An apparatus for vehicle management and control is provided. The apparatus includes a processing unit, a vehicle lock controller and a non-contactable radio frequency (RF) reader. When an identification (ID) tag approaches to the non-contactable RF reader in a predetermined distance, the non-contactable RF reader reads ID information in the ID tag, and transmits the ID information to the processing unit. The processing unit executes a task according to an interaction relationship between the non-contactable RF reader and the ID tag or a user.

### CROSS-REFERENCE TO RELATED APPLICATION

This application claims the priority benefit of Taiwan application serial no. 103109033, filed on Mar. 13, 2014. The entirety of the above-mentioned patent application is hereby incorporated by reference herein and made a part of this specification.

### BACKGROUND OF THE INVENTION

1. Field of the Invention

The invention relates to an electronic apparatus, and particularly relates to a vehicle control and management apparatus and a vehicle control and management method.

2. Description of Related Art

Due to the rapidity of information spreading and the increasing value of travel for people nowadays, the vehicle rental market in e-commerce is also becoming matured. In addition, unattended car rentals with flexible hours and locations of rental also become a novel business model. However, in terms of the hardware framework, such business model requires the controller of the door lock of the vehicles and the electronic apparatus capable of calculating the rental fees. Currently, what is common on the market is to choose one of the functions to implement or use separate electronic apparatuses to implement the two different functions. However, it requires costs for the service providers to configure the hardware facilities in addition to the costs for vehicles, and the operating errors or operating complexity may disturb the users and even result in vehicle rental disputes.

### SUMMARY OF THE INVENTION

The invention provides an apparatus for vehicle management and control and a method for vehicle management and control capable of locking/unlocking a vehicle or controlling a rental state through an interactive action with the user.

The apparatus for vehicle management and control includes a processing unit, a vehicle lock controller coupled with the processing unit, and a non-contactable radio frequency reader coupled with the processing unit. When an identification tag approaches to the non-contactable radio frequency reader in a predetermined distance, the non-contactable radio frequency reader reads identification information in the identification tag and transmits the identification information to the processing unit. The processing unit performs a vehicle management and control operation based on the identification information.

The method for vehicle management and control of the invention is adapted for an apparatus for vehicle management and control and includes the following. When an identification tag approaches in a predetermined distance, identification information in the identification tag is read. A vehicle management and control operation is performed based on the identification information.

According to the above description, the invention provides the apparatus for vehicle management and control and the method for vehicle management and control. An interaction relationship between the identification tag (or the user) and the non-contactable radio frequency reader is utilized to control the vehicle lock controller to perform operations such as terminating or activating a lock state or terminating or activating a rental state.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram illustrating an apparatus for vehicle management and control and an identification tag according to an embodiment of the invention.

FIG. 2 is a flowchart illustrating a method for vehicle management and control according to an embodiment of the invention.

FIG. 3 is a functional block diagram illustrating an apparatus for vehicle management and control according to an embodiment of the invention.

FIG. 4 is a flowchart illustrating a method for vehicle management and control according to an embodiment of the invention.

FIG. 5 is a flowchart illustrating a method for vehicle management and control according to an embodiment of the invention.

FIG. 6 is a functional block diagram illustrating an apparatus for vehicle management and control according to an embodiment of the invention.

FIG. 7 is a flowchart illustrating a method for vehicle management and control according to an embodiment of the invention.

FIG. 8 is a functional block diagram illustrating an apparatus for vehicle management and control according to an embodiment of the invention.

FIG. 9 is a schematic diagram illustrating a relationship between a sensing module, a non-contactable radio frequency reader, and an identification tag according to an embodiment of the invention.

FIG. 10 is a flowchart illustrating a method for vehicle management and control according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

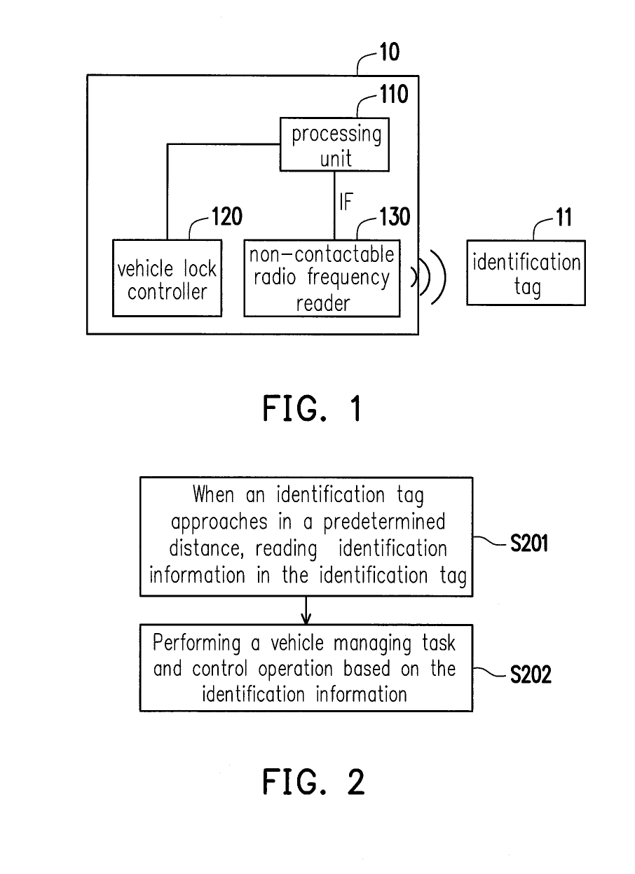

In the invention, an apparatus for vehicle management and control is suitable to manage and control a door lock and a rental state of a car, a motorcycle, and a bicycle, etc., for example. FIG. 1 is a functional block diagram illustrating an apparatus for vehicle management and control and an identification tag according to an embodiment of the invention. Referring to FIG. 1, an apparatus for vehicle management and control 10 includes a processing unit 110, a vehicle lock controller 120 coupled with the processing unit 110, and a non-contactable radio frequency reader 130 coupled with the processing unit 110. For example, when a vehicle under control is a car, the vehicle lock controller 120 may be a door lock controller of the car, and may also be an activating controller 120 of a car engine, or a lock controller having the functions at the same time. When the vehicle under control is a car, the apparatus for vehicle management and control 10 may be fixedly disposed in the car. For example, the apparatus for vehicle management and control 10 may be disposed around a door handle or around a front pillar of the car. The apparatus for vehicle management and control 10 may also be fixedly disposed on an outer surface of the car, such as around a door handle of the driver seat. When the vehicle lock controller 120 only functions as the door lock controller, the apparatus for vehicle management and control 10 may also be fixedly disposed external to the vehicle, such as being disposed together with a parking lot. The invention is not limited by the embodiment described above.

When an identification tag 11 approaches to the non-contactable radio frequency reader 130 in a predetermined distance, i.e., the identification tag 11 enters a sensing range of the radio frequency reader 130 (e.g. within a few centimeters), the non-contactable radio frequency reader 130 reads identification information IF in the identification tag 11 and transmits the identification information IF to the processing unit 110. When the processing unit 110 receives the identification information IF, the processing unit 110 performs a vehicle management and control operation based on the identification information.

For example, in this embodiment, when the processing unit 110 identifies the identification tag 11 as an authenticated tag based on the identification information IF, the processing unit 110 retrieves a time duration value or a number of times read that the non-contactable radio frequency reader 130 reads the identification tag 11 within the predetermined time through the non-contactable radio frequency reader 130 to perform an operation corresponding to the time duration value or the number of times read. Furthermore, the operation includes controlling the vehicle lock controller to terminate or activate a lock state and terminating or activating a rental state.

In addition, the identification tag 11 may be used as an identity and a key of the vehicle. The identification tag 11 may be a radio frequency identification (RFID) tag, and the non-contactable radio frequency reader 130 may be a reader of the RFID tag. The identification tag 11 and the non-contactable radio frequency reader 130 may be realized in a different way, as long as the non-contactable radio frequency reader 130 reads the identification information IF from the identification tag 11 in a non-contactable manner.

FIG. 2 is a flowchart illustrating a method for vehicle management and control according to an embodiment of the invention. In addition, the method for vehicle management and control is suitable for the apparatus for vehicle management and control 10 shown in FIG. 1. Referring to FIG. 2, first of all, when the identification tag approaches in the predetermined distance, the identification information in the identification tag is read at Step S201. Then, at Step S202, the vehicle management and control operation is performed based on the identification information.

In addition, the vehicle management and control operation may include controlling the vehicle lock controller 120 to terminate or activate the lock state (such as unlock/lock the door lock of the vehicle, or turn on/turn off), terminating or activating the rental state, activating a rental-terminating process, activating a rental-changing process, and activating a communication process, such as activating a communication module (not shown) in the apparatus for vehicle management and control 10 to make a phone call to a customer service center of a rental service provider or to a roadside service provider, etc.

In brief, in this embodiment, after identifying the identification tag 11 as the authenticated tag, the processing unit 110 of the apparatus for vehicle management and control 10 may continuously detect the time duration value of the identification tag and/or the number of times read that the non-contactable radio frequency reader 130 reads the identification tag (which corresponds to a number of times that the identification tag approaches and leaves the non-contactable radio frequency reader 130) through the non-contactable radio frequency reader 130, so as to determine an operation that the user requires the apparatus for vehicle management and control 10 to accomplish. Detailed description of the operation will be provided below with an accompanying embodiment.

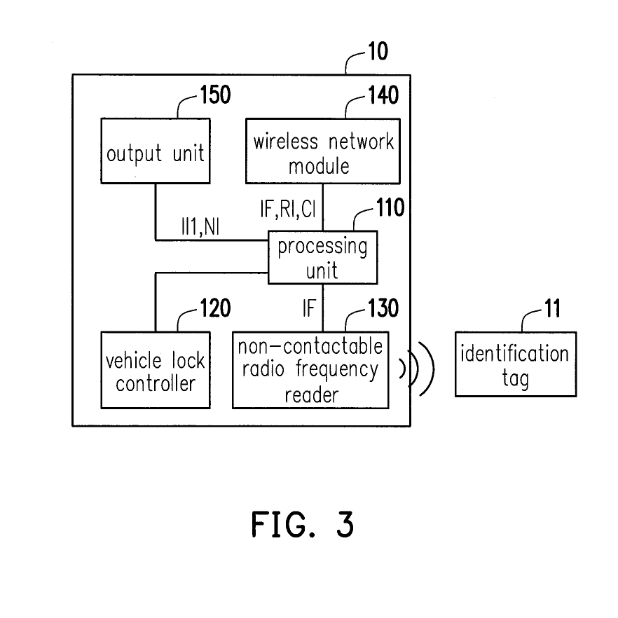

FIG. 3 is a functional block diagram illustrating an apparatus for vehicle management and control according to an embodiment of the invention. In addition, coupling relations between the elements may be referred to the embodiment shown in FIG. 1. Thus, no further details will be reiterated below. The embodiment shown in FIG. 3 differs from the embodiment shown in FIG. 1 in that, in the embodiment shown in FIG. 3, the apparatus for vehicle management and control 10 further includes a wireless network module 140 and an output unit 150. The wireless network module 140 is coupled with the processing unit 110 and may be connected to the Internet wirelessly. In addition, when the processing unit 110 receives the identification information IF from the non-contactable radio frequency reader 130, the processing unit 110 may directly compares the identification information IF to a list of authenticated tags stored in the processing unit 110 in advance to determine whether the identification tag 11 is the authenticated tag.

However, in this embodiment, the processing unit 110 may also transmit the identification information IF to a server in the Internet (not shown, such as a server set up and maintained by the rental service provider of the vehicle) through the wireless network module 140. When the server receives the identification information IF transmitted by the wireless network module 140, whether the identification tag 11 is the authenticated tag may be determined based on the list of authenticated tags or other information in the server. Alternatively, the identification tag 11 may be authenticated based on the identification information IF. When the server confirms that the identification tag 11 is the authenticated tag, confirmation information CI may be transmitted to the wireless network module 140 of the apparatus for vehicle management and control 10. When the processing unit 110 receives the confirmation information CI in response to the identification information IF through the wireless network module 140, the processing unit 110 may determine whether the identification tag 11 is the authenticated tag based on the confirmation information CI.

Besides, when the processing unit 110 activates the rental state, terminates the rental state, activates the rental-terminating process, or activates the rental-changing process (e.g. determining based on the time duration value and/or the number of times read and then performing an operation including activating or terminating the rental state), the processing unit 110 may transmit rental information RI corresponding to the rental state, rental-terminating process, or rental-changing process to the server in the Internet through the wireless network module 140, such that the rental service provider setting up the server may retrieve the rental state or a rental-terminating or rental-changing request corresponding to the apparatus for vehicle management and control 10, calculate a corresponding amount of fee based on the rental information RI, charge the user a rental fee, or activate another mechanism to satisfy the user's rental-terminating or rental-changing request.

The output unit 150 is coupled with the processing unit 110 and may include a display screen, a speaker, or an alarming lamp. When the processing unit 110 determines that the identification tag 11 is the authenticated tag based on the identification information IF, the processing unit 110 then outputs prompting information II1 through the output unit 150. For example, the display screen of the output unit 150 may display the prompting information, the speaker may produce a sound or play a voice message corresponding to prompting information II1, or the alarming lamp may signal in a color or produce a light signal corresponding to the prompting information II1, or combinations thereof. The invention is not limited thereto. When the processing unit 110 activates or terminates the rental state, and terminates or activate the lock state, the processing unit 110 may also output notifying information NI corresponding to the rental state and the lock state through the output unit 150. For example, the display screen of the output unit 150 may display notifying information NI, the speaker produce a sound or play a voice message different from the prompting information II1 but corresponding to the notifying information NI, or the alarming lamp may signal in a color or produce a light signal corresponding to the notifying information N1, or the above ways may be combined.

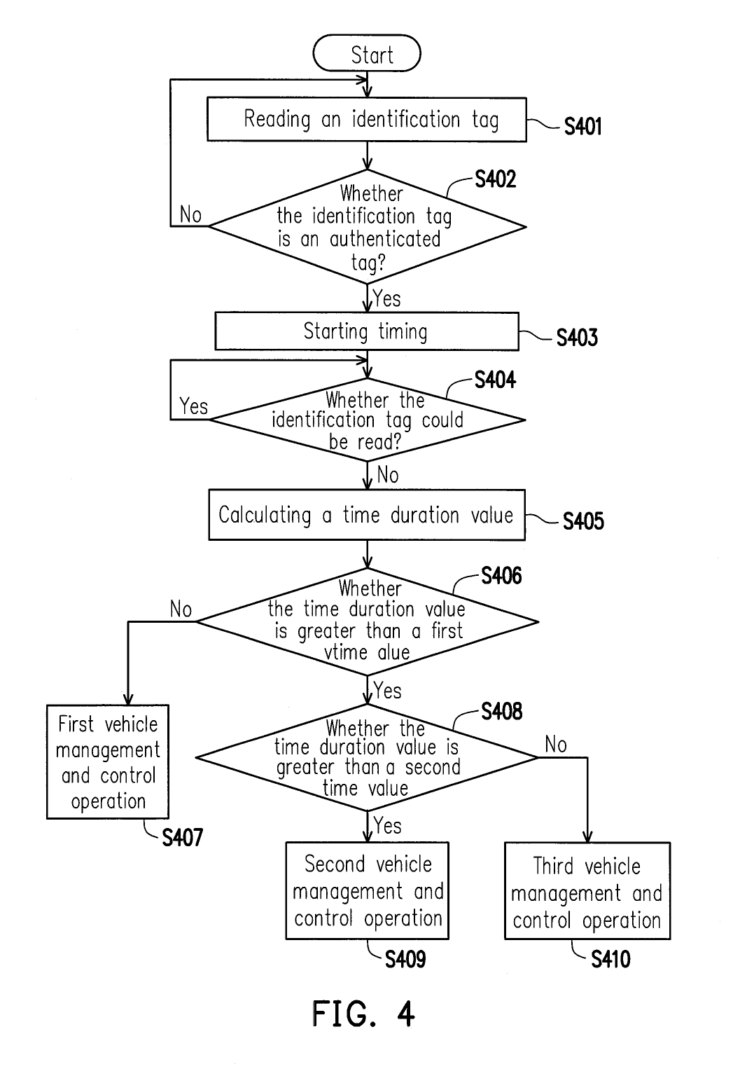

FIG. 4 is a flowchart illustrating a method for vehicle management and control according to an embodiment of the invention. The embodiment shown in FIG. 4 illustrates a way of embodying that the processing unit 110 of the apparatus for vehicle management and control 10 retrieves the time duration value that the non-contactable radio frequency reader 130 reads the identification tag 11 within the predetermined time to determine to perform the vehicle management and control operation corresponding to the time duration value.

Referring to FIGS. 3 and 4, first of all, the processing unit 110 retrieves the identification information IF in the identification tag 11 through the non-contactable radio frequency reader 130 (Step S401), and determines whether the identification tag 11 is the authenticated tag based on the identification information IF (Step S402). If the identification tag 11 is not the authenticated tag, the processing unit 110 then continuously determines whether the identification tag 11 or other identification tags may be read in the predetermined distance through the non-contactable radio frequency reader 130 (e.g., the tag may be held by a user to approach to the non-contactable radio frequency reader 130.)

If the identification tag 11 is the authenticated tag (Yes in Step 402), the processing unit 110 then starts timing to calculate a time duration that the identification tag 11 is continuously read. If the non-contactable radio frequency reader 130 continuously reads the identification tag (Yes in Step S404), the processing unit 110 then continuously accumulates the time duration. If the non-contactable radio frequency reader 130 could not read the identification tag 11 (No, Step S404), the processing unit 110 then calculates the time duration accumulated (Step 405).

After calculating the time duration value, the processing unit 110 then determines whether the time duration value is greater than a first time value, between the first time value and a second time value, or greater than a second time value (Steps S406 and S408). When the processing unit 110 determines that the time duration value is smaller than the first time value (No in Step S406), the processing unit 110 then performs a first vehicle management and control operation (Step S407).

When the processing unit 110 determines that the time duration value is greater than then second time value (Yes in Step S406, and Yes in Step S408), the processing unit 110 then performs a second vehicle management and control operation (Step S409). When the processing unit 110 determines that the time duration value is between the first and second time values (Yes in Step S406 and No in Step S408), the processing unit 110 then performs a third vehicle management and control operation (Step S410).

In addition, the first time value and the second time value may be adjusted based on practical needs. The processing unit 110 may also display a corresponding light signal or prompting information when the first time value or the second time value is reached in timing. Moreover, the first vehicle management and control operation, the second vehicle management and control operation, and the third vehicle management and control operation is the vehicle management and control operation that includes controlling the vehicle lock controller 120 to terminate or activate the lock state, terminate, activating the rental state, activating the rental-terminating process, activating the rental-changing process, or activating the communication process to contact the customer service center of the rental service provider or the roadside service provider, etc. In another embodiment, another time value with a different time duration (e.g. a third or fourth time value) may be set in addition to the first and second time values, so as to add another executable vehicle management and control operation. The invention is not limited thereto.

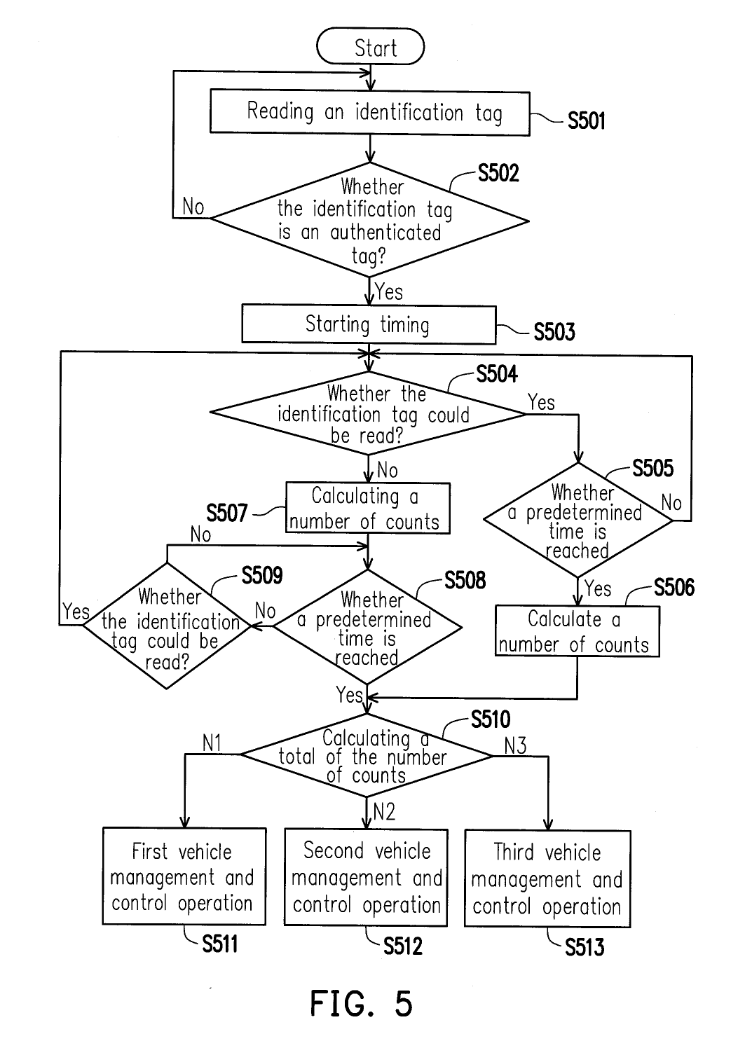

FIG. 5 is a flowchart illustrating a method for vehicle management and control according to an embodiment of the invention. The embodiment shown in FIG. 5 illustrates way of embodying that the processing unit 110 of the apparatus for vehicle management and control 10 retrieves the number of times read that the non-contactable radio frequency reader 130 reads the identification tag 11 within the determined time (e.g. 2 to 3 seconds) to determine to perform the vehicle management and control operation corresponding to the number of times read.

Referring to FIGS. 3 and 5, first of all, the processing unit 110 retrieves the identification information IF in the identification tag 11 through the non-contactable radio frequency reader 130 (Step S501), and determines whether the identification tag 11 is the authenticated tag based on the identification information IF (Step S502). If the identification tag 11 is not the authenticated tag, the processing unit 110 then continuously determines whether the identification tag 11 or other identification tags may be read in the predetermined distance through the non-contactable radio frequency reader 130.

If the identification tag 11 is the authenticated tag, (Yes in Step S502), the processing unit 110 starts timing (Step S503). When timing starts, the processing unit 10 then determines whether the non-contactable radio frequency reader 130 reads the identification tag 11 (Step S504). If the non-contactable radio frequency reader130 reads the identification tag 11, the processing unit 110 then determines whether the predetermined time is reached (Step S505). If the predetermined time is reached (Yes in Step S505), the processing unit 110 adds a number of counts by 1 (Step S506). If the predetermined time is not reached (No in Step S505), the processing unit 110 then continuously determines whether the identification tag 11 is read through the non-contactable radio frequency reader 130 (Step S504).

If the identification tag 11 is not read (No in Step S04), the processing unit 110 then adds a number of counts by 1 (Step S507), and determines again whether the predetermined time is reached (Step S508). If the predetermined time is not reached yet, the processing unit 110 then determines whether the non-contactable radio frequency reader 130 still reads the identification tag 11 (Step S509). If the predetermined time is reached, the processing unit 110 then adds the number of counts that the identification tag 11 is not read by 1. After the predetermined time is reached (Yes in Step S08), the processing unit 110 then calculates a total of the number of counts. In this embodiment, the processing unit 110 sets a first number N1, a second number N2, and a third number N3, corresponding to one time of times read, two times of times read, and three times of times read, for example, in default. When the total of the number of counts is the first number N1, the second number N2, or the third number N3, the processing unit 110 then correspondingly performs the first, second, or third vehicle management and control operation (Step S511 to S513). Moreover, the first vehicle management and control operation, the second vehicle management and control operation, and the third vehicle management and control operation may include controlling the vehicle lock controller 120 to terminate or activate the lock state, terminating or activating the rental state, activating the rental-terminating process, activating the rental-changing process, or activating the communication process to contact the customer service center of the rental service provider or the roadside service provider, etc., as described above. The processing unit 110 may also set another number (e.g. a fourth number or a fifth number) in default, so as to add another executable vehicle management and control operation. The invention is not limited thereto.

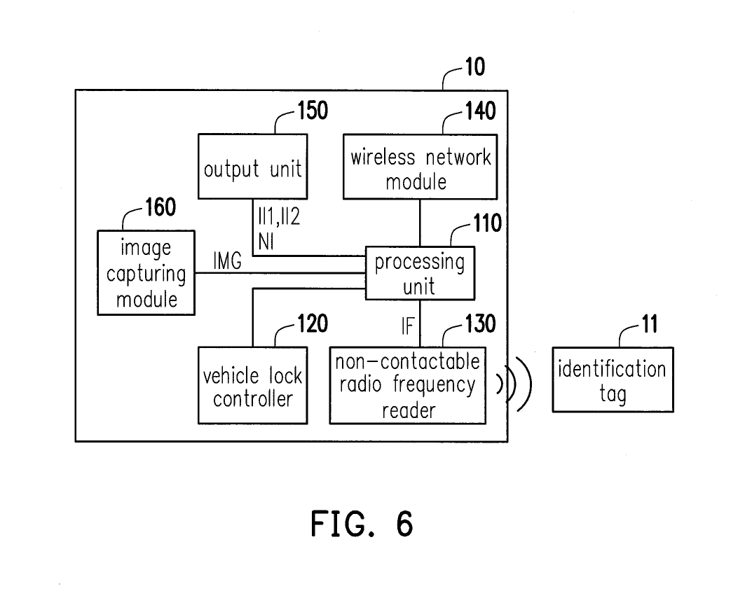

The invention also provides an apparatus for vehicle management and control capable of determining the vehicle management and control operation that the user requires the apparatus for vehicle management and control 10 to accomplish based on a user's gesture. FIG. 6 is a functional block diagram illustrating an apparatus for vehicle management and control according to an embodiment of the invention. Referring to FIG. 6, the apparatus for vehicle management and control 10 includes the processing unit 110, the vehicle lock controller 120 coupled with the processing unit 110, the non-contactable radio frequency reader 130, the wireless network module 140, and the output unit 150. Functions and coupling relations of the elements may be referred to the embodiments shown in FIGS. 1 and 3, so no further details in this respect will be reiterated.

What differs from the embodiments shown in FIGS. 1 and 3 is that in the embodiment shown in FIG. 6, the apparatus for vehicle management and control 10 further includes an image capturing module 160 coupled with the processing unit 110. When the identification tag 11 approaches to the non-contactable radio frequency reader 130 in the predetermined distance, the non-contactable radio frequency reader 130 reads the identification information IF in the identification tag 11 and transmits the identification information IF to the processing unit 110. When the processing unit 110 determines that the identification tag 11 is the authenticated tag based on the identification information IF (or based on the confirmation information received in response to the identification information IF after transmitting the identification information IF to the Internet), the processing unit 110 captures a plurality of images IMG that are continuous (i.e. consecutive images) through the image capturing module 160. The processing unit 110 identifies a gesture included in the images, and performs the vehicle management and control operation corresponding to the gesture based on the gesture.

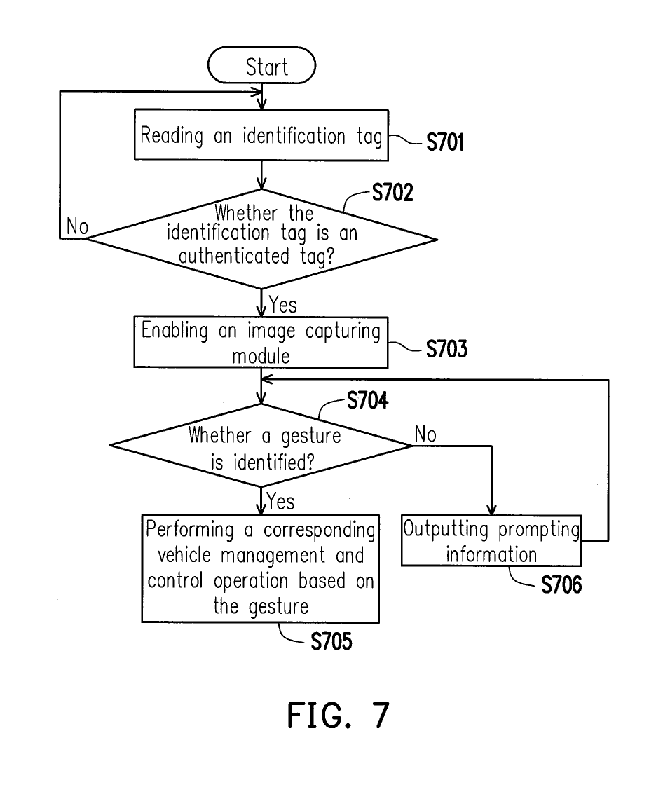

FIG. 7 is a flowchart illustrating a method for vehicle management and control according to an embodiment of the invention. Specifically, the method shown in FIG. 7 is suitable for the apparatus for vehicle management and control 10 of the embodiment shown in FIG. 6. Referring to FIGS. 6 and 7, first of all, the processing unit 110 retrieves the identification information IF in the identification tag 11 through the non-contactable radio frequency reader 130 (Step S701), and determines whether the identification tag 11 is the authenticated tag based on the identification information IF (Step S702). If the identification tag 11 is not the authenticated tag, the processing unit 110 then continuously detects and reads the identification tag 11 or other identification tags through the non-contactable radio frequency reader 130.

When the processing unit 110 determines that the identification tag 11 is the authenticated tag, the processing unit 110 enables the image capturing module 160, so as to capture the images IMG to identify the gesture in the images. In addition, the processing unit 110 may also transmit the prompting information II1 to the display unit, so as to prompt the user to use the gesture to operate the apparatus for vehicle management and control 10 or instruct the user on how to use the gesture to perform the corresponding vehicle management and control operation (Step 703). Then, the processing unit 110 identifies the gesture in the images based on the images IMG captured by the image capturing module 160 (Step S704). If the processing unit 110 is not able to identify the gesture in the images IMG (No in Step S704), it is possible that the user does not use the correct gesture to operate. The processing unit 110 then outputs the prompting information 112 through the output unit 150 again, so as to instruct the user again on how to use the gesture to perform the corresponding vehicle management and control operation. When the processing unit 110 identifies the gesture in the images IMG (Yes in Step S704), the processing unit 110 then performs the corresponding vehicle management and control operation based on the gesture that is identified.

The gesture may be configured in advance in the processing unit 110. For example, a gesture with a lateral movement of a hand corresponds to the first vehicle management and control operation, a gesture with a vertical movement of a hand corresponds to the second vehicle management and control operation, and a gesture that makes a circle sign with a finger corresponds to the third vehicle management and control operation. A variety of gestures and corresponding vehicle management and control operations may be customized by the designer of the apparatus for vehicle management and control 10 or the user based on practical needs.

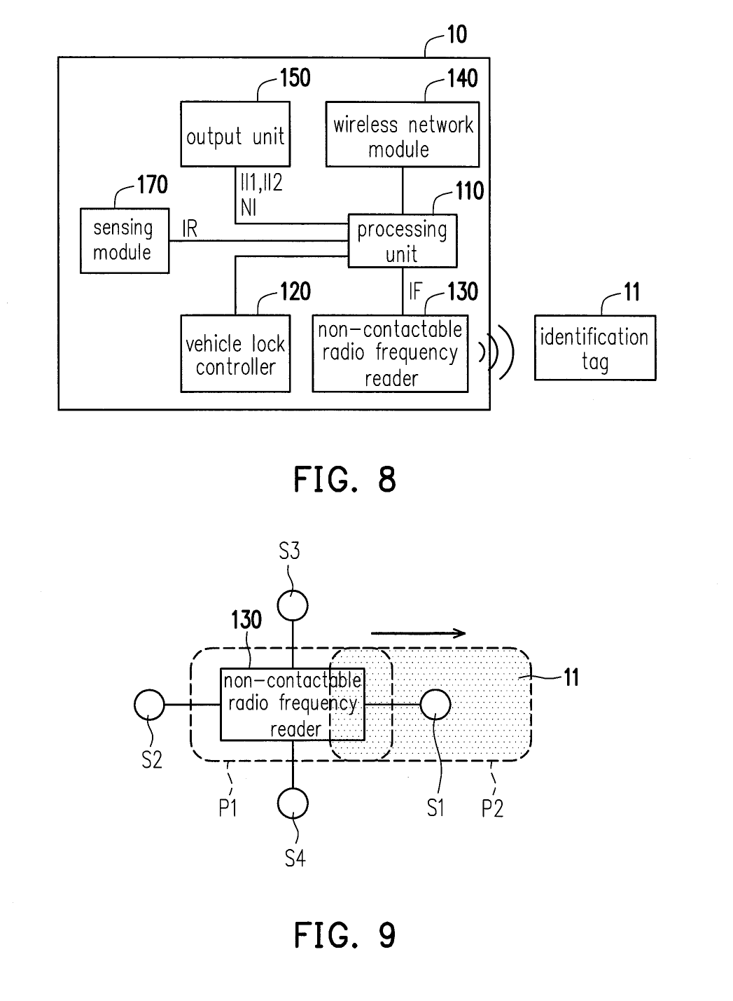

The invention also provides an apparatus for vehicle management and control capable of using an interactive action between the identification tag 11 (or a key configured together with identification tag) and the non-contactable radio frequency reader 130 to determine the vehicle management and control operation that the user requires the apparatus for vehicle management and control 10 to accomplish. FIG. 8 is a functional block diagram illustrating an apparatus for vehicle management and control according to an embodiment of the invention. Referring to FIG. 8, the apparatus for vehicle management and control 10 includes the processing unit 110, the vehicle lock controller 120 coupled with the processing unit, the non-contactable radio frequency reader 130, the wireless network module 140, and the output unit 150. Functions and coupling relations of the elements may be referred to the embodiments shown in FIGS. 1 and 3, so no further details in this respect will be reiterated. What differs from the embodiments shown in FIGS. 1 and 3 is that in the embodiment shown in FIG. 8, the apparatus for vehicle management and control 10 further includes a sensing module 170 disposed around the non-contactable radio frequency reader 130 and coupled with the processing unit 110.

When the identification tag 11 approaches to the non-contactable radio frequency reader 130 in the predetermined distance, the non-contactable radio frequency reader 130 reads the identification information IF in the identification tag 11 and transmits the identification information IF to the processing unit 110. When the processing unit 110 determines that the identification tag 11 is the authenticated tag based on the identification information IF (or based on the confirmation information received in response to the identification information IF after transmitting the identification information IF to the Internet), the processing unit 110 retrieves an interactive action IR between the identification tag 11 and the non-contactable radio frequency reader 130 through the sensing module 170 and performs the vehicle management and control operation corresponding to the interactive action IR based on the interactive action IR.

The interactive action IR refers to a relative movement that the user may perform in correspondence with the non-contactable radio frequency reader 130 when holding the identification tag 11, which may include interaction relationships such as upward, downward, leftward, rightward movements of the identification tag 11 with respect to a center of the non-contactable radio frequency reader 130 and rotating and circling actions of the identification tag 11 over the non-contactable radio frequency reader 130. The processing unit 110 may set the interactive actions to respectively correspond to different vehicle management and control operations. FIG. 9 is a schematic diagram illustrating a relationship between a sensing module, a non-contactable radio frequency reader, and an identification tag according to an embodiment of the invention. In this embodiment, the sensing module 170 includes sensors S1 to S4 disposed around the non-contactable radio frequency reader 130. In addition, the sensors S1 to S4 may be light sensors, motion sensors, infrared sensors, or proximity sensors, etc., which are sensors capable of determining a movement of an object based on sensing data.

Referring to FIG. 9, when the identification tag 11 moves from a position P1 to a position P2 (i.e. moving from immediately over the non-contactable radio frequency reader 130 to the right of the non-contactable radio frequency reader 130), a sensing data of the sensor S1 changes, while sensing data of the remaining sensors S2 to S4 are the same. After receiving the sensing data transmitted from the sensors S1 to S4, the processing unit 110 may determine the interactive action between the identification tag 11 and the non-contactable radio frequency reader 130 is a rightward movement of the identification tag 11. In another embodiment, the sensing module may also include a micro-processor (not shown) coupled between the sensors S1 to S4 and the processing unit 110. The micro-processor thus receives the sensing data transmitted from the sensors S1 to S4, determines that the interactive action between the identification tag 11 and the non-contactable radio frequency reader 130 is retrieved, and then transmits the interactive action IR to the processing unit 110.

In addition, in this embodiment, the sensors S1 and S4 are respectively configured at top, bottom, right, and left sides of the non-contactable radio frequency reader 130. However, a number of the sensors (e.g. the sensors S1 to S4) and disposed positions of the sensors may be adjusted based on practical needs. For example, if the processing unit 110 is in a configuration that only the leftward and rightward interactive actions IR have the corresponding vehicle management and control operations, it is then unnecessary to dispose the sensors S3 and S4 at the top and bottom sides of the non-contactable radio frequency sensor 130.

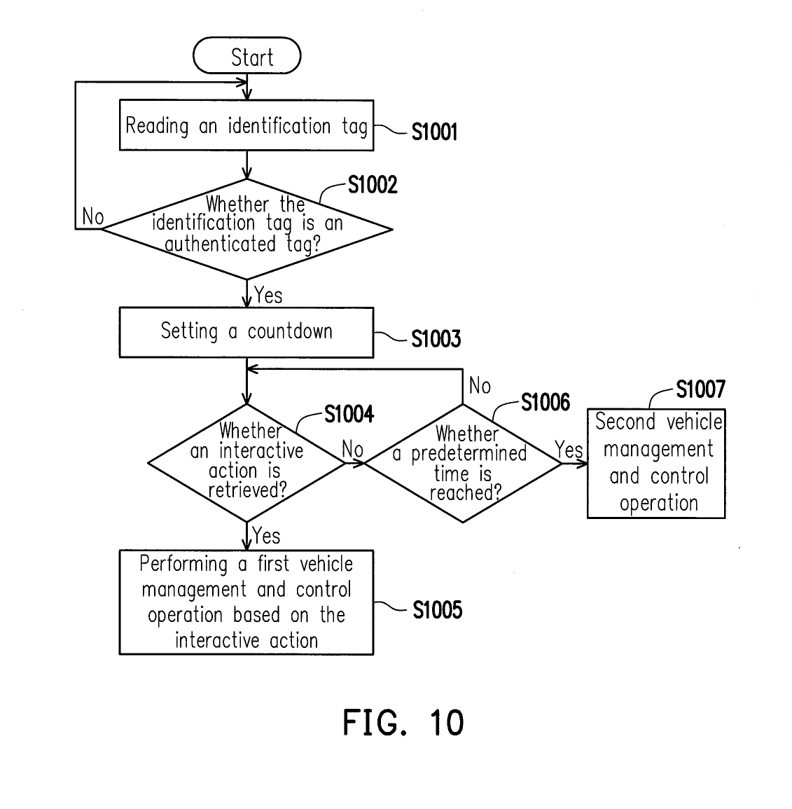

FIG. 10 is a flowchart illustrating a method for vehicle management and control according to an embodiment of the invention. Specifically, the method shown in FIG. 10 is suitable for the apparatus for vehicle management and control 10 of the embodiment shown in FIG. 8. Referring to FIGS. 8 and 10, first of all, the processing unit 110 retrieves the identification information IF in the identification tag 11 through the non-contactable radio frequency reader 130 (Step S1001), and determines whether the identification tag 11 is the authenticated tag based on the identification information IF (Step S1002). If the identification tag 11 is not the authenticated tag, the processing unit 110 then continuously reads the identification tag 11 or other identification tags through the non-contactable radio frequency reader 130.

When the processing unit 110 determines that the identification tag 11 is the authenticated tag based on the identification information IF (or based on the confirmation information received in response to the identification information IF after transmitting the identification information IF to the Internet) (Yes in Step 1002), the processing unit 110 sets that a countdown starts (Step S1003) and determines whether the interactive action IR is retrieved when the predetermined time is reached (Step S1004). When the interactive action IR is retrieved from the sensing module 170 in the predetermined time (Yes in Step 1004), the processing unit 110 then performs the first vehicle management and control operation based on the interactive action (Step 1005). For example, a leftward movement corresponds to terminating/activating the rental sate, and a rightward movement corresponds to contacting a customer service representative. If the predetermined time is reached, and no interactive action IR is retrieved from the sensing module 170 (No in Step 1004, and Yes in Step 1006), the processing unit 110 may perform the second vehicle management and control operation in correspondence with an outcome of determination (Step S1007). In this embodiment, the second vehicle management and control operation corresponds to the vehicle and management control operation that the processing unit 110 performs in default, and the second vehicle management and control operation may correspond to an operation that is most frequently used by the user, such as controlling the vehicle lock controller 120 to terminate/activate the lock state. However, the invention is not limited thereto.

In view of the foregoing, the invention provides the apparatus for vehicle management and control and the method for vehicle management and control, which are suitable for the vehicle rental service provider to rent a vehicle to the user when no real person is in service. In addition, the apparatus for vehicle management and control is capable of performing the corresponding vehicle management and control operation, including locking/unlocking a vehicle, starting/stalling a vehicle, activating/terminating the rental state, contacting the customer service center of the rental service provider, terminating the rental, or contacting the roadside service provider based on the interaction relationship between the identification tag held by the user and the non-contactable radio frequency reader. In this way, the rental service provider that sets up the apparatus for vehicle management and control may simplify a rental process and configuration costs of facilities by integrating simple auto-identification into a single apparatus, such that the user may rent a vehicle through a simple operating process under a circumstance that no real person is in service. Thus, possible disturbances in renting a vehicle may be avoided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for vehicle management and control, comprising:
a processing unit;
a vehicle lock controller, coupled with the processing unit; and
a non-contactable radio frequency reader, coupled with the processing unit,
wherein when an identification tag approaches to the non-contactable radio frequency reader in a predetermined distance, the non-contactable radio frequency reader reads identification information in the identification tag and transmits the identification information to the processing unit, and
the processing unit performs a vehicle management and control operation based on the identification information.

2. The apparatus for vehicle management and control as claimed in claim 1, wherein:
the vehicle management and control operation comprises controlling the vehicle lock controller to terminate or activate a lock state, terminating or activating a rental state, activating a rental-terminating process, activating a rental-changing process, and activating a communication process.

3. The apparatus for vehicle management and control as claimed in claim 2, wherein:
the processing unit determines whether the identification tag is an authenticated tag based on the identification information, and when the processing unit determines that the identification tag is the authenticated tag, the processing unit performs the vehicle management and control operation based on the identification information.

4. The apparatus for vehicle management and control as claimed in claim 3, wherein the apparatus for vehicle management and control comprises:
a wireless network module, coupled with the processing unit and connected to the Internet wirelessly,
wherein when the processing unit receives the identification information from the non-contactable radio frequency reader, the processing unit transmits the identification information to the Internet through the wireless network module, and
when the processing unit receives confirmation information in response to the identification information through the wireless network module, the processing unit determines whether the identification tag is the authenticated tag based on the confirmation information.

5. The apparatus for vehicle management and control as claimed in claim 4, wherein:
when the processing unit activates the rental state, terminates the rental state, activates the rental-terminating process, or activates the rental-changing process, the processing unit transmits rental information to the Internet through the wireless network module based on the rental state, the rental-terminating process, or the rental-changing process.

6. The apparatus for vehicle management and control as claimed in claim 3, wherein the apparatus for vehicle management and control comprises:
an output unit, coupled with the processing unit,
wherein when the processing unit determines that the identification tag is the authenticated tag based on the identification information, the processing unit outputs prompting information through the output unit, and
when the processing unit performs the vehicle management and control operation, the processing unit outputs notifying information corresponding to the vehicle management and control operation through the output unit.

7. The apparatus for vehicle management and control as claimed in claim 3, wherein:
the processing unit retrieves a time duration value or a number of times read that the non-contactable radio frequency reader reads the identification tag within a predetermined time through the non-contactable radio frequency reader to perform the vehicle management and control operation corresponding to the time duration value or the number of times read.

8. The apparatus for vehicle management and control as claimed in claim 3, wherein the apparatus for vehicle management and control further comprises:
an image capturing module, coupled with the processing unit,
wherein the processing unit retrieves a plurality of images consecutively through the image capturing module, identifies a gesture comprised in the images, and performs the vehicle management and control operation corresponding to the gesture based on the gesture.

9. The apparatus for vehicle management and control as claimed in claim 3, wherein the apparatus for vehicle management and control further comprises:
a sensing module, disposed around the non-contactable radio frequency reader and coupled with the processing unit,
wherein the processing unit retrieves an interactive action between the identification tag and the non-contactable radio frequency reader through the sensing module, and performs the vehicle management and control operation corresponding to the interactive action based on the interactive action.

10. A method for vehicle management and control adapted for an apparatus for vehicle management and control, comprising:
when an identification tag approaches in a predetermined distance, reading identification information in the identification tag; and
performing a vehicle management and control operation based on the identification information.

11. The method for vehicle management and control as claimed in claim 10, wherein:
the vehicle management and control operation comprises controlling a vehicle lock controller of apparatus for vehicle management and control to terminate or activate a lock state, terminating or activating a rental state, activating a rental-terminating process, activating a rental-changing process, and activating a communication process.

12. The method for vehicle management and control as claimed in claim 11, wherein performing the vehicle management and control operation based on the identification information further comprises:
determining whether the identification tag is an authenticated tag based on the identification information, and when it is determined that the identification tag is the authenticated tag, performing the vehicle management and control operation based on the identification information.

13. The method for vehicle management and control as claimed in claim 12, wherein determining whether the identification tag is the authenticated tag based on the identification information comprises:
transmitting the identification information to the Internet; and
when confirmation information in response to the identification information is received, determining whether the identification tag is the authenticated tag based on the confirmation information.

14. The method for vehicle management and control as claimed in claim 11, wherein performing the vehicle management and control operation based on the identification information comprises:
when activating the rental state, terminating the rental state, activating the rental-terminating process, or activating the rental-changing process, transmitting rental information to the Internet based on the rental state, the rental-terminating process, or the rental-changing process.

15. The method for vehicle management and control as claimed in claim 11, wherein performing the vehicle management and control operation based on the identification information comprises:
when the identification tag is determined to be the authenticated tag based on the identification information, outputting prompting information through an output unit of the apparatus for vehicle management and control; and
when performing the vehicle management and control operation, outputting notifying information corresponding to the vehicle management and control operation through the output unit of the apparatus for vehicle management and control.

16. The method for vehicle management and control as claimed in claim 11, wherein performing the vehicle management and control operation based on the identification information comprises:
retrieving a time duration value or a number of times read that the [a] non-contactable radio frequency reader of the apparatus for vehicle management and control reads the identification tag within a predetermined time; and
performing the vehicle management and control operation corresponding to the time duration value or the number of times read based on the time duration value or the number of times read.

17. The method for vehicle management and control as claimed in claim 11, wherein performing the vehicle management and control operation based on the identification information comprises:
retrieving a plurality of images consecutively through an image capturing module of the apparatus for vehicle management and control, identifying a gesture comprised in the images, and performing the vehicle management and control operation corresponding to the gesture based on the gesture.

18. The method for vehicle management and control as claimed in claim 11, wherein performing the vehicle management and control operation based on the identification information comprises:
retrieving an interactive action between the identification tag and the non-contactable radio frequency reader through a sensing module of the apparatus for vehicle management and control, and performing the vehicle management and control operation corresponding to the interactive action based on the interactive action.
